(19) United States
(12) Patent Application Publication
(10) Pub. No.: US 2022/0083694 A1
(43) Pub. Date: Mar. 17, 2022

(54) AUDITING SYSTEM

(71) Applicant: FUJIFILM BUSINESS INNOVATION CORP., Tokyo (JP)

(72) Inventor: Mitsuhisa KAMEI, Kanagawa (JP)

(73) Assignee: FUJIFILM BUSINESS INNOVATION CORP., Tokyo (JP)

(21) Appl. No.: 17/144,233

(22) Filed: Jan. 8, 2021

(30) Foreign Application Priority Data
Sep. 11, 2020 (JP) 2020-152910

(51) Int. Cl. G06F 21/71; G06F 21/60; H04L 9/32

(52) U.S. Cl. CPC G06F 21/71; G06F 2221/2101; H04L 9/3247; G06F 21/602

(57) ABSTRACT

An auditing system includes a processor configured to obtain system information as information about apparatus safety from an apparatus that is to be audited, the system information describing predetermined items, convert, on the basis of content of each of the items, the system information to safety-degree information indicating the degree of safety, encrypt the safety-degree information in an environment in which a measure is taken for protection against an analysis action, and output the encrypted safety-degree information and the safety-degree information in plain text.

### CROSS-REFERENCE TO RELATED APPLICATIONS

This application is based on and claims priority under 35 USC 119 from Japanese Patent Application No. 2020-152910 filed Sep. 11, 2020.

### BACKGROUND

### (i) Technical Field

The present disclosure relates to an auditing system.

### (ii) Related Art

Various units for diagnosis and assessment of safety or maintenance of safe states have been proposed and introduced for information processing systems.

Japanese Unexamined Patent Application Publication No. 2007-316686 discloses a server in which security data, which is used to assess the security strength, and security points, each of which indicates the degree of contribution to the security strength, are stored in association with each other. The server obtains pieces of security data from an information terminal, and calculates, for storage, the security strength of the information terminal on the basis of these pieces of information.

Japanese Unexamined Patent Application Publication No. 2020-004006 discloses a technique. In the technique, it is determined whether a vulnerability exists in software, which is installed in an apparatus, on the basis of apparatus information collected from the apparatus. If it is determined that a vulnerability exists in the software, it is determined whether a patch for fixing the vulnerability has been applied to the software. If it is determined that such a patch has not been applied, management information for managing the vulnerability in the software is generated.

Japanese Patent No. 4396585 discloses a technique for causing a computer to implement the following processes: generating diagnosis work information based on information about a diagnosis target apparatus and authentication information of a diagnosis worker; diagnosing a vulnerability of a network system of the diagnosis target apparatus which is specified by using the diagnosis work information; encrypting the diagnosis result and the authentication information of the diagnosis worker and generating an encrypted vulnerability diagnosis file. In addition, a diagnosis company key, which is given to each diagnosis company, is encrypted, and added to the encrypted vulnerability diagnosis file.

Japanese Unexamined Patent Application Publication No. 2010-266966 discloses a technique for a computer connected to a network over which computer systems of organizations are connected to each other. In the technique, the computer collects log information and asset management information in the computer system of each organization. The computer performs statistical processing on the collected log information and asset management information for each specific group of organizations, and makes a relative assessment on information security of each organization in the group. Thus, the computer obtains an index indicating in which degree each organization has taken measures for security.

When, for example, as in a supply chain, multiple organizations collaboratively work, the maintenance of safety of the whole information processing system of the collaborating organizations needs a required level of safety provided for the information processing system of each collaborating organization. Therefore, an organization may want information about safety of the information processing system of a different organization working collaboratively with the organization.

In contrast, for example, in terms of confidentiality protection, many organizations do not want to present detailed information about their information processing systems even to collaborating organizations.

### SUMMARY

Aspects of non-limiting embodiments of the present disclosure relate to a technique which, unlike the case of direct assessment of the configuration of an information processing system of interest, enables acquisition of information about safety of the information processing system without presentation of information about the specific configuration of the information processing system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an auditing system including a processor. The processor is configured to obtain system information as information about apparatus safety from an apparatus that is to be audited. The system information describes predetermined items. The processor is configured to convert, on the basis of content of each of the items, the system information to safety-degree information indicating the degree of safety. The processor is configured to encrypt the safety-degree information in an environment in which a measure is taken for protection against an analysis action. The processor is configured to output the encrypted safety-degree information and the safety-degree information in plain text.

### BRIEF DESCRIPTION OF THE DRAWINGS

Exemplary embodiment of the present disclosure will be described in detail based on the following figures, wherein:

FIG. 1 is a diagram illustrating the overall configuration of an information processing system to which an auditing system according to the present exemplary embodiment is applied;

FIG. 2 is a diagram illustrating the configuration of an auditing system according to the present exemplary embodiment;

FIG. 3A is a diagram illustrating an exemplary operation system (OS) assessment table which is included in an assessment DB and which describes the assessment levels of OS types;

FIG. 3B is a diagram illustrating an exemplary OS assessment table which is included in an assessment DB and which describes the assessment levels of the attributes of patches applied to OSs;

FIG. 4A is a diagram illustrating an exemplary antivirus-software assessment table which is included in an assessment DB and which describes the assessment levels of antivirus-software types;

FIG. 4B is a diagram illustrating an exemplary antivirus-software assessment table which is included in an assessment DB and which describes the assessment levels of the attributes of pattern data applied to antivirus software;

FIG. 5A is a diagram illustrating an exemplary software assessment table which is included in an assessment DB and which describes the assessment levels of software types;

FIG. 5B is a diagram illustrating an exemplary software assessment table which is included in an assessment DB and which describes prohibited versions of software;

FIG. 6A is a diagram illustrating an exemplary vulnerability assessment table which is included in an assessment DB and which describes the assessment levels of vulnerability types;

FIG. 6B is a diagram illustrating an exemplary vulnerability assessment table which is included in an assessment DB and which describes objects having vulnerabilities and their patch types;

FIG. 7 is a diagram illustrating an exemplary unauthorized-connection countermeasure assessment table included in an assessment DB;

FIG. 8 is a diagram illustrating an implementation example of an auditing system according to the present exemplary embodiment;

FIG. 9 is a diagram illustrating another implementation example of an auditing system according to the present exemplary embodiment;

FIG. 10 is a diagram illustrating an exemplary hardware configuration of a computer serving as a summarizing apparatus or an investigation target apparatus;

FIG. 11 is a diagram illustrating an exemplary configuration of a display screen on which a user is notified of an assessment result; and

FIG. 12 is a diagram illustrating exemplary setting of security levels required individually for business types.

### DETAILED DESCRIPTION

Referring to the attached drawings, an exemplary embodiment of the present disclosure will be described in detail below.

### The Configuration of Target Apparatuses

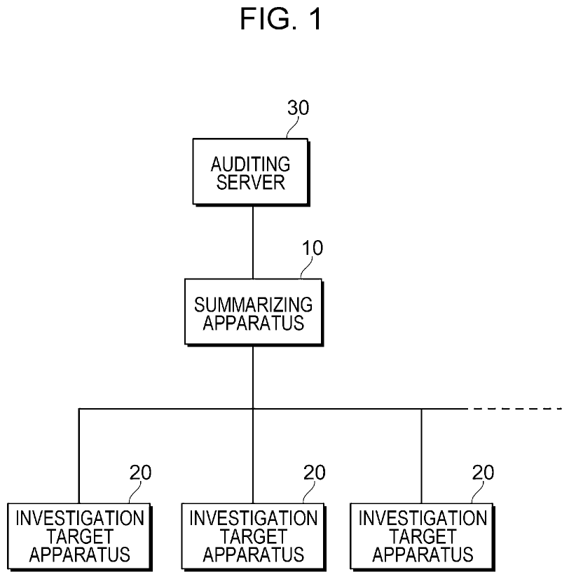

FIG. 1 is a diagram illustrating the overall configuration of an information processing system to which an auditing system according to the present exemplary embodiment is applied. The information processing system according to the present exemplary embodiment includes a summarizing apparatus 10, investigation target apparatuses 20, and an auditing server 30. The summarizing apparatus 10 summarizes information of each of the investigation target apparatuses 20 and transmits the summarized information to the auditing server 30. Each investigation target apparatus 20 is an apparatus that is to be investigated (audited) in terms of security. The auditing server 30 obtains information about the investigation target apparatuses 20 which is summarized by the summarizing apparatus 10, and audits the security levels (information indicating the degree of safety) of the investigation target apparatuses 20. In FIG. 1, the single summarizing apparatus 10 is connected to the auditing server 30. Actually, multiple summarizing apparatuses 10 are connected to the auditing server 30. Each of the summarizing apparatuses 10 receives, for summarization, information from its corresponding investigation target apparatuses 20, and transmits the summarized information to the auditing server 30.

The summarizing apparatus 10 is connected to the investigation target apparatuses 20, for example, over a local area network (LAN). The summarizing apparatus 10 is connected to the auditing server 30, for example, over the Internet. The communication lines of the networks may be wired or wireless. In consideration of security, the network which connects the summarizing apparatus 10 to the investigation target apparatuses 20 may be set so that access from the outside is restricted. Similarly, the network which connects the summarizing apparatus 10 to the auditing server 30 may be formed, for example, of a dedicated line or a virtual private network (VPN) which is set on the Internet.

### The Configuration of the Auditing System 100

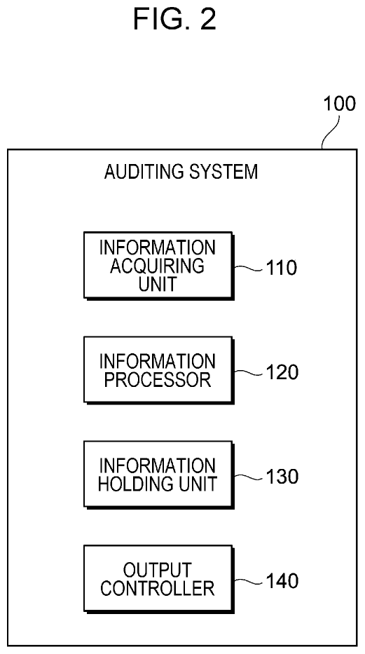

FIG. 2 is a diagram illustrating the configuration of an auditing system according to the present exemplary embodiment. An auditing system 100 includes an information acquiring unit 110, an information processor 120, an information holding unit 130, and an output controller 140. The functions are implemented so as to be allocated to the summarizing apparatus 10 and each investigation target apparatus 20 which are included in the information processing system to which the auditing system 100 is applied.

The information acquiring unit 110 acquires system information from each investigation target apparatus 20. The system information indicates information about items predetermined as information about safety of an apparatus. For example, the system information is acquired from each investigation target apparatus 20 itself by using software installed in the investigation target apparatus 20. Examples of the software for acquiring the system information may include dedicated software prepared for acquisition of the system information according to the present exemplary embodiment and may also include a typical information technique (IT) asset management tool. The IT asset management tool indicates a tool (software) for managing hardware, software, and other assets related to information technique which are included in an information processing apparatus. The IT asset management tool is not limiting as long as the tool is capable of acquiring information of audit targets in the present exemplary embodiment. Any existing tool may be used. The specific content of the system information acquired by the information acquiring unit 110 will be described below.

The information processor 120 performs various processes on the information acquired by the information acquiring unit 110. Specifically, the information processor 120 assesses information, which is to be processed, (the system information acquired by the investigation target apparatus 20) in terms of security, and the information processor 120 performs processes, such as electronic signature (hereinafter simply referred to as “signature”) and encryption, on the assessment result. The specific description about the processes performed by the information processor 120 will be made below.

The functions of the information processor 120 may be included in the summarizing apparatus 10, or may be included in each investigation target apparatus 20. If the functions of the information processor 120 are included in the summarizing apparatus 10, the summarizing apparatus 10 obtains the system information from each investigation target apparatus 20, and performs processes by using the functions of the information processor 120 on the obtained system information. In contrast, if the functions of the information processor 120 are included in each investigation target apparatus 20, the investigation target apparatus 20 performs processes by using the functions of the information processor 120 on the system information acquired by using the function of the information acquiring unit 110, and transmits the process result to the summarizing apparatus 10.

Most of the processes may be performed by the information processor 120 under an analysis-preventing environment. The analysis-preventing environment indicates an environment in which measures for protection from analysis actions from the outside are taken. An example of the analysis actions may be so-called reverse engineering. Specifically, it corresponds, for example, to actions, such as execution on a debugger and decryption through disassembling. The analysis-preventing environment for prevention of these actions is implemented through software or hardware. Specifically, in the case of software, methods, such as code encryption, detecting a debugger and halting its execution when the debugger is detected, code complication, process-flow complication, and execution on a virtual machine, are used. Examples of process-flow complication include a method in which the process is jumped after a small unit of processing and in which, every time the process is jumped, calculation is performed after jumping. In the case of hardware, for example, the central processing unit (CPU) has a function of disabling execution using a debugger or a function of providing a memory space which is not viewed from a different process. The analysis-preventing environment used in the present exemplary embodiment may be an environment constructed by using a unit for constructing an existing analysis-preventing environment. A specific unit for implementing the analysis-preventing environment is set, for example, in accordance with the specification and operation of the auditing system 100, the audit purpose, and apparatuses and systems that are to be audited.

The information holding unit 130 holds information used in processes performed by the information processor 120. Specifically, the information holding unit 130 holds an assessment database (DB), which is used for assessment of information performed by the information processor 120, and requirement criterion information which is information for specifying assessment criteria required for the investigation target apparatuses 20. For each assessment item in the assessment performed by the information processor 120, the assessment DB associates, for storage, the types of assessment target with assessment information determined in accordance with the types. The specific description about the assessment DB will be made below. In the case where the summarizing apparatus 10 includes the information processor 120, the summarizing apparatus 10 also includes the information holding unit 130. In contrast, in the case where each investigation target apparatus 20 includes the information processor 120, the investigation target apparatus 20 also includes the information holding unit 130.

The output controller 140 outputs a process result, which is obtained by the information processor 120, to the auditing server 30. The output controller 140 also outputs information, which is to be output to the auditing server 30, in order to notify a user of the summarizing apparatus 10 of the information. The information itself, which is to be output to the auditing server 30, is encrypted. In contrast, to present the output information to the user, the user is notified of the information in plain text. The output content from the output controller 140 will be described below in detail.

### An Exemplary Configuration of the Assessment DB

An exemplary configuration of the assessment DB held by the information holding unit 130 will be described. As described above, in the assessment DB, the types of assessment target and their assessment information are held for each assessment item used in assessment performed by the information processor 120. The assessment items and their assessment information are set individually, for example, in accordance with the specification and operation of the auditing system 100 according to the present exemplary embodiment and the audit purpose. Herein, an exemplary configuration of the assessment DB will be described in the case where assessment is performed on each of the items: the operating system (OS); the antivirus software; software (application); vulnerability; unauthorized-connection prevention measures.

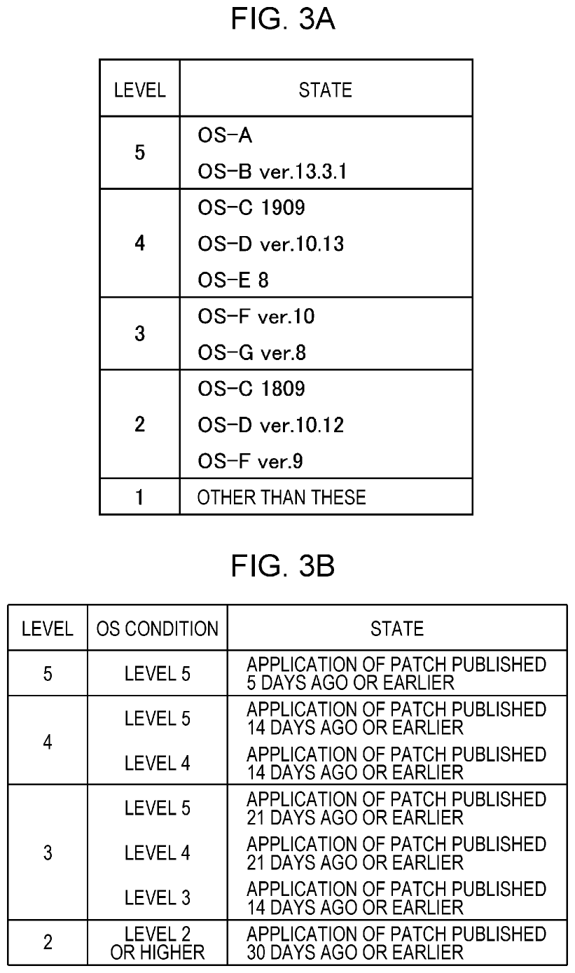

FIGS. 3A and 3B are diagrams illustrating exemplary OS assessment tables included in the assessment DB. FIG. 3A illustrates a table describing the assessment levels for OS types. FIG. 3B illustrates a table describing the assessment levels of the attributes of patches applied to OSs. In the example illustrated in FIG. 3A, the two OS types, “OS-A” and “OS-B version 13.3.1”, are regarded as having security level 5 (the highest security level in FIG. 3A) which is illustrated as “Level 5” in FIG. 3A. The three OS types, “OS-C1909”, “OS-D version 10.13”, and “OS-E8”, are regarded as having security level 4. The two OS types, “OS-F version 10” and “OS-G version 8”, are regarded as having security level 3. The three OS types, “OS-C1809”, “OS-D version 10.12”, and “OS-F version 9”, are regarded as having security level 2. The OSs other than these are regarded as having security level 1 (the lowest security level in FIG. 3A).

In the example illustrated in FIG. 3B, OSs, which have security level 5 and to which patches published five days ago or earlier have been applied (illustrated as “application of patch” in FIG. 3B), are regarded as having security level 5. OSs, which have security level 5 and to which patches published 14 days ago or earlier have been applied, are regarded as having security level 4. OSs, which have security level 5 and to which patches published 21 days ago or earlier have been applied, are regarded as having security level 3. OSs, which have security level 4 and to which patches published 14 days ago or earlier have been applied, are regarded as having security level 4. OSs, which have security level 4 and to which patches published 21 days ago or earlier have been applied, are regarded as having security level 3. OSs, which have security level 3 and to which patches published 14 days ago or earlier have been applied, are regarded as having security level 3. OSs, which have security level 2 or higher and to which patches published 30 days ago or earlier have been applied, are regarded as having security level 2. Thus, the security level of an OS is determined in consideration of the security level of an OS itself and the attribute of its applied patch. For example, “OS-A” illustrated in FIG. 3A has security level 5. However, an OS of “OS-A” only with old patches is assessed as having a lower security level, such as security level 4 or security level 3.

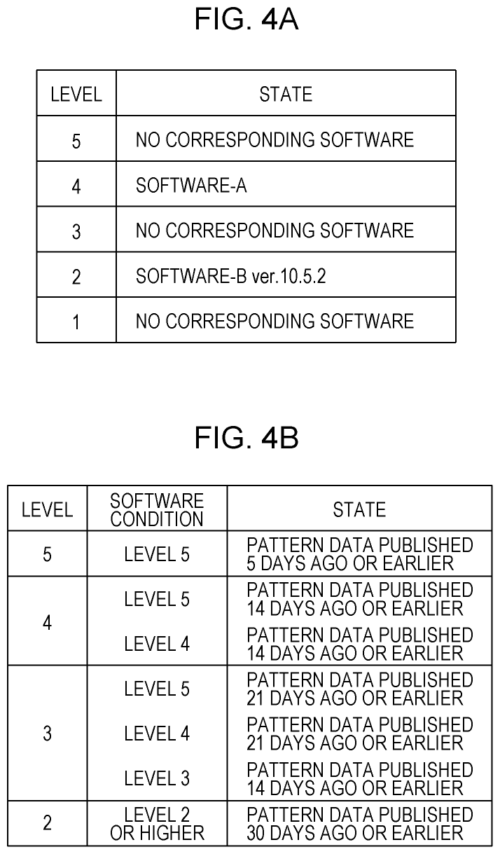

FIGS. 4A and 4B are diagrams illustrating exemplary antivirus-software assessment tables included in the assessment DB. FIG. 4A illustrates a table describing the assessment levels of antivirus software types. FIG. 4B illustrates a table describing the assessment levels of the attributes of pattern data applied to antivirus software. In the example illustrated in FIG. 4A, “Software-A” is regarded as having security level 4, and “Software-B version 10.5.2” is regarded as having security level 2. No antivirus software corresponds to security levels 5, 3, and 1.

In the example illustrated in FIG. 4B, antivirus software, which has security level 5 and to which pattern data published five days ago or earlier has been applied, is regarded as having security level 5. Antivirus software, which has security level 5 and to which pattern data published 14 days ago or earlier has been applied, is regarded as having security level 4. Antivirus software, which has security level 5 and to which pattern data published 21 days ago or earlier has been applied, is regarded as having security level 3. Antivirus software, which has security level 4 and to which pattern data published 14 days ago or earlier has been applied, is regarded as having security level 4. Antivirus software, which has security level 4 and to which pattern data published 21 days ago or earlier has been applied, is regarded as having security level 3. Antivirus software, which has security level 3 and to which pattern data published 14 days ago or earlier has been applied, is regarded as having security level 3. Antivirus software, which has security level 2 or higher and to which pattern data published 30 days ago or earlier has been applied, is regarded as having security level 2. Thus, the security level of antivirus software is determined in consideration of the security level of the antivirus software itself and the attribute of applied pattern data. For example, antivirus software itself of “Software-A” illustrated in FIG. 4A has security level 4. However, if only old pattern data has been applied to the antivirus software, this case is assessed as having a lower security level, such as security level 3 or security level 2.

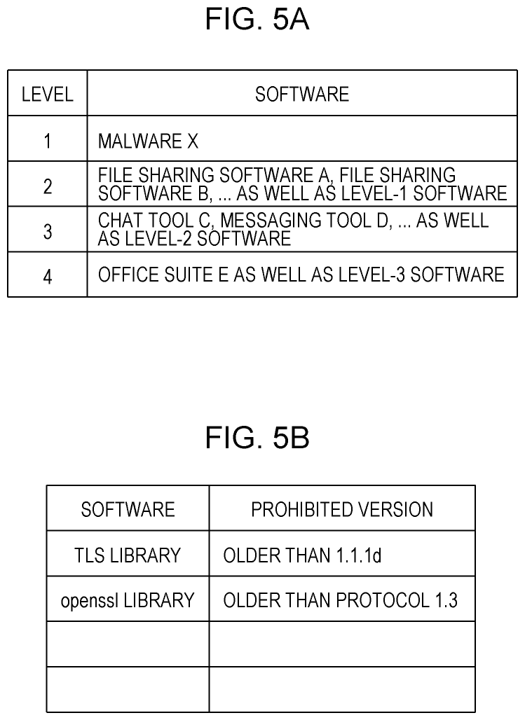

FIGS. 5A and 5B are diagrams illustrating exemplary software assessment tables included in the assessment DB. FIG. 5A illustrates a table describing the assessment levels of software types. FIG. 5B illustrates a table describing prohibited versions of software. In the example illustrated in FIG. 5A, when the application software installed in an investigation target apparatus 20 includes “Malware X”, the application software is regarded as having security level 1 (the lowest security level in FIG. 5A). When the application software installed in an investigation target apparatus 20 includes, for example, “File sharing software A” or “File sharing software B” as well as the level-1 software, the application software is regarded as having security level 2. When the application software installed in an investigation target apparatus 20 includes, for example, “Chat tool C” or “Messaging tool D” as well as the level-2 software, the application software is regarded as having security level 3. When the application software installed in an investigation target apparatus 20 includes, for example, “Office suite E” as well as the level-3 software, the application software is regarded as having security level 4. As illustrated in FIG. 5B, versions older than version 1.1.1d of TLS library and versions older than protocol 1.3 of openssl library are prohibited from being installed in the investigation target apparatuses 20.

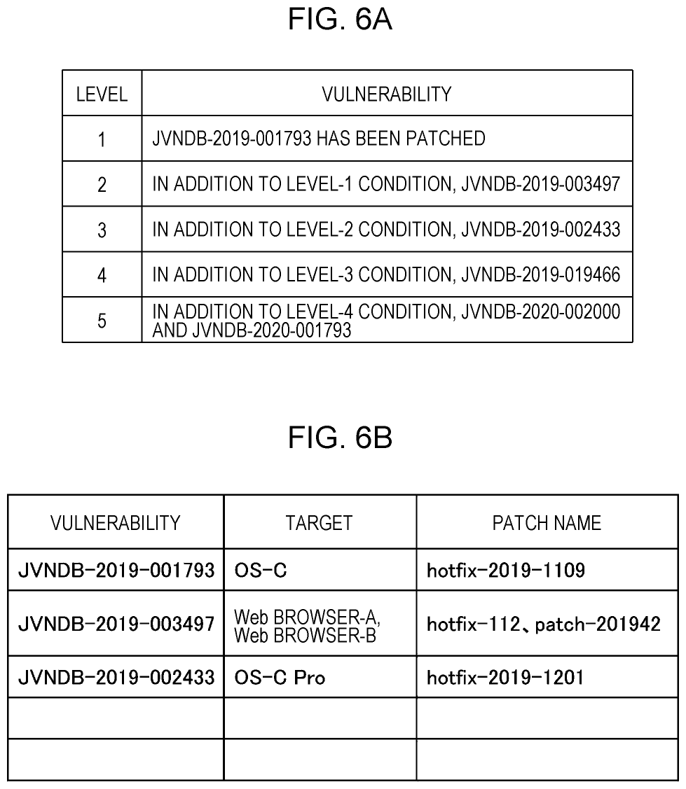

FIGS. 6A and 6B are diagrams illustrating exemplary vulnerability assessment tables included in the assessment DB. FIG. 6A illustrates a table describing the assessment levels of vulnerability types. FIG. 6B illustrates a table describing targets having vulnerabilities and patch types. In the example illustrated in FIG. 6A, when an investigation target apparatus 20 has a system which does not have the vulnerability of JVNDB-2019-001793 registered in Vulnerability Countermeasure Information Database (JVNDB), or when the investigation target apparatus 20 has been patched against the vulnerability, the investigation target apparatus 20 is regarded as having security level 1 (the lowest security level in FIG. 6A). In addition to the vulnerability condition in security level 1, when an investigation target apparatus 20 has a system which does not have the vulnerability of JVNDB-2019-003497, or when the investigation target apparatus 20 has been patched against the vulnerability, the investigation target apparatus 20 is regarded as having security level 2. In addition to the vulnerability condition in security level 2, when an investigation target apparatus 20 has a system which does not have the vulnerability of JVNDB-2019-002433, or when the investigation target apparatus 20 has been pathed against the vulnerability, the investigation target apparatus 20 is regarded as having security level 3. In addition to the vulnerability condition in security level 3, when an investigation target apparatus 20 has a system which does not have the vulnerability of JVNDB-2019-019466, or when the investigation target apparatus 20 has been patched against the vulnerability, the investigation target apparatus 20 is regarded as having security level 4. In addition to the vulnerability condition in security level 4, when an investigation target apparatus 20 has a system which does not have the vulnerabilities of JVNDB-2020-002000 and JVNDB-2020-001793, or when the investigation target apparatus 20 has been patched against the vulnerabilities, the investigation target apparatus 20 is regarded as having security level 5.

FIG. 6B illustrates targets having vulnerabilities and patches for resolving the vulnerabilities. In the example illustrated in FIG. 6B, the vulnerability of JVNDB-2019-001793, which aims at OS-C, is resolved by applying the patch, “hotfix-2019-1109”. The vulnerability of JVNDB-2019-003497, which aims at Web browser-A and Web browser-B, is resolved by applying the patch, “hotfix-112” or “patch-201942”. The vulnerability of JVNDB-2019-002433, which aims at OS-C Pro, is resolved by applying the patch, “hotfix-2019-1201”.

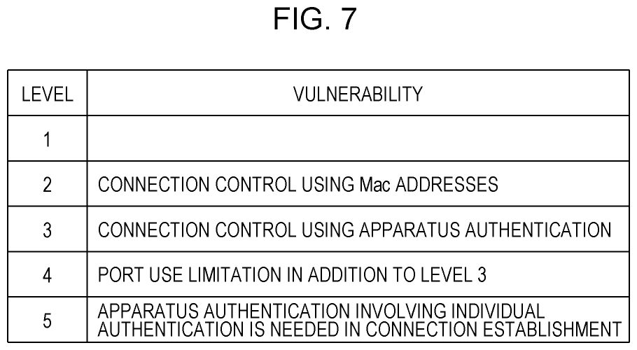

FIG. 7 is a diagram illustrating an exemplary unauthorized-connection countermeasure assessment table included in the assessment DB. FIG. 7 illustrates the security levels of countermeasures against unauthorized connection. In the example illustrated in FIG. 7, in the case of connection control using Mac addresses in an investigation target apparatus 20, the investigation target apparatus 20 is regarded as having security level 2. In the example in FIG. 7, no countermeasures are set for security level 1. Thus, security level 2 is the lowest security level. In the case of connection control using apparatus authentication in an investigation target apparatus 20, the investigation target apparatus 20 is regarded as having security level 3. In the case of port use limitation in addition to connection control using apparatus authentication in an investigation target apparatus 20, the investigation target apparatus 20 is regarded as having security level 4. In the case where an investigation target apparatus 20 exerts control so that apparatus authentication involving individual authentication is needed in establishment of a connection, the investigation target apparatus 20 is regarded as having security level 5.

As described above, the exemplary configuration of the assessment DB is described in terms of some assessment items. The assessment items and their assessment content which are described by referring to FIGS. 3A to 7 are merely exemplary. Assessment may be performed in terms of assessment items other than those described above. Not all the items described above are necessarily assessed. Actual assessment items and their assessment content are set specifically in installation of the auditing system 100 according to the present exemplary embodiment. In the exemplary configuration, the tables for the software types and the tables about patches and pattern data are described as being included in the same assessment DB. Alternatively, the tables for software itself, such as OS and antivirus software, and the tables about patches and pattern data, which are often updated, may be constructed as separate databases.

### Implementation Example of the Auditing System 100

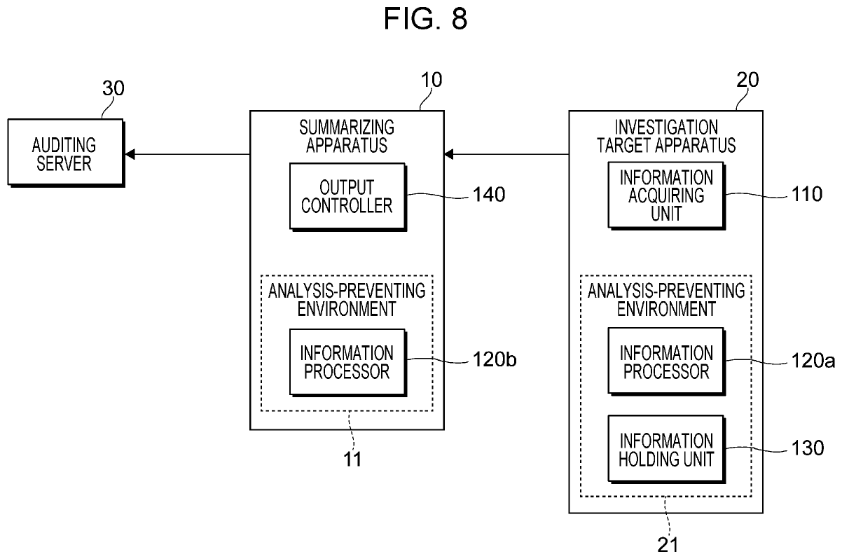

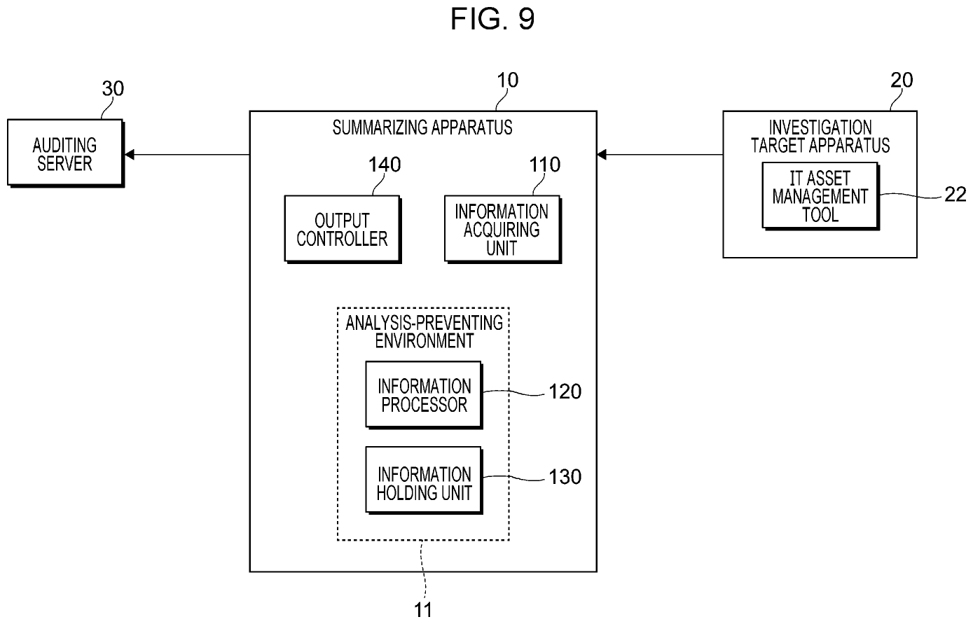

Implementation examples of the auditing system 100 according to the present exemplary embodiment for the information processing system having the configuration illustrated in FIG. 1 will be described. According to the present exemplary embodiment, the functions of the auditing system 100 which are described by referring to FIG. 2 are assigned to the summarizing apparatus 10 and each investigation target apparatuses 20 included in the information processing system as illustrated in FIG. 1, achieving various implementation examples. An implementation example in which processes such as assessment of acquired system information are performed by each investigation target apparatus 20, and an implementation example in which the processes are performed by the summarizing apparatus 10 will be described by referring to FIGS. 8 and 9.

FIG. 8 is a diagram illustrating an implementation example of the auditing system 100 according to the present exemplary embodiment. In the implementation example illustrated in FIG. 8, each investigation target apparatus 20 includes the information acquiring unit 110, a part of the information processor 120, and the information holding unit 130. The summarizing apparatus 10 includes a part of the information processor 120 and the output controller 140. In the configuration of the implementation example, the part of the information processor 120 which is included in each investigation target apparatus 20 is referred to as an information processor 120a. The part of the information processor 120 which is included in the summarizing apparatus 10 is referred to as an information processor 120b.

The information processor 120a included in each investigation target apparatus 20 uses system information, which is acquired by the information acquiring unit 110, to assess the security level, and encrypts the assessment result. Thus, each investigation target apparatus 20 includes the information processor 120a as well as the information holding unit 130 including the assessment DB used to assess the security level. As described above, the information processor 120a performs assessment of the security level and encryption under an analysis-preventing environment 21 constructed in the investigation target apparatus 20. Therefore, the assessment DB in the information holding unit 130 and an encryption key used in the encryption are also stored in a storage unit (for example, a storage device in which encryption is performed in writing data) included in the analysis-preventing environment 21. As the encryption key, an encryption key based on information (for example, identification information of the investigation target apparatus 20 and information about the acquisition date and time of the system information) associated with the investigation target apparatus 20, from which the system information is acquired, and an operation of acquiring the system information may be used. If the assessment DB is signed to prevent the assessment DB from being tampered, the signing is performed in the analysis-preventing environment 21, and the signature key for the assessment DB is also stored in the storage unit included in the analysis-preventing environment 21.

Typically, processes are performed in an analysis-preventing environment with a heavier load than that in the case in which processes are performed outside the analysis-preventing environment. For example, the analysis-preventing environment causes a decrease in the execution speed or an increase in cost for application. Therefore, some of the processes performed by the information processor 120a, such as signing the assessment DB, may be performed outside the analysis-preventing environment 21. In this case, the processes for generating data used for audit of an investigation target apparatus 20, such as assessment of the security level and encryption, may be performed in the analysis-preventing environment 21. The other processes may be performed outside the analysis-preventing environment 21. The assessment result encrypted by the information processor 120a in an investigation target apparatus 20 is transmitted with the assessment result in plain text to the summarizing apparatus 10.

The information processor 120b included in the summarizing apparatus 10 signs the assessment result obtained from an investigation target apparatus 20. The signing is performed in an analysis-preventing environment 11 constructed in the summarizing apparatus 10. A signature key used in the signing is also stored in a storage unit located in the analysis-preventing environment 11. At least the encrypted assessment result is signed. In addition, the assessment result in plain text may be signed. The output controller 140 of the summarizing apparatus 10 transmits, to the auditing server 30, an assessment result which has been encrypted by the information processor 120a and which has been signed by the information processor 120b. Before transmission of the assessment result to the auditing server 30, the output controller 140 notifies the assessment result in plain text to a user of the summarizing apparatus 10. Notification of the assessment result is performed, for example, by displaying the assessment result on a display apparatus. The user may refer to the notified assessment result to check the content of the assessment result which is to be transmitted from the summarizing apparatus 10 to the auditing server 30.

FIG. 9 is a diagram illustrating another implementation example of the auditing system 100 according to the present exemplary embodiment. In the implementation example illustrated in FIG. 9, the summarizing apparatus 10 includes the information acquiring unit 110, the information processor 120, the information holding unit 130, and the output controller 140. In this implementation example, each investigation target apparatus 20 obtains system information by using an IT asset management tool 22, and transmits the obtained system information to the summarizing apparatus 10.

The information acquiring unit 110 included in the summarizing apparatus 10 acquires the system information from each investigation target apparatus 20. The information processor 120 included in the summarizing apparatus 10 assesses the security level by using the system information acquired by the information acquiring unit 110, encrypts the assessment result, and signs the encrypted assessment result. These processes are performed in the analysis-preventing environment 11 constructed in the summarizing apparatus 10. Therefore, the assessment DB in the information holding unit 130, the encryption key used in the encryption, and the signature key used in signing are also stored in the storage unit in the analysis-preventing environment 11. At least the encrypted assessment result is signed. In addition, the assessment result in plain text may be signed. If the assessment DB is signed to prevent the assessment DB from being tampered, the signing is performed in the analysis-preventing environment 11. In addition, the signature key for the assessment DB is also stored in the storage unit included in the analysis-preventing environment 11. As described by referring to the implementation example in FIG. 8, to reduce the load on processes performed in the analysis-preventing environment 11, processes other than the processes for generating data used in audit of an investigation target apparatus 20, such as assessment of the security level, encryption and signing of the assessment result, may be performed outside the analysis-preventing environment 11.

The output controller 140 of the summarizing apparatus 10 transmits, to the auditing server 30, the assessment result encrypted and signed by the information processor 120. Before transmission of the assessment result to the auditing server 30, the output controller 140 notifies the assessment result in plain text to a user of the summarizing apparatus 10. Notification of the assessment result is performed, for example, by displaying the assessment result on a display apparatus.

### The Hardware Configuration of the Summarizing Apparatus 10 and Each Investigation Target Apparatus 20

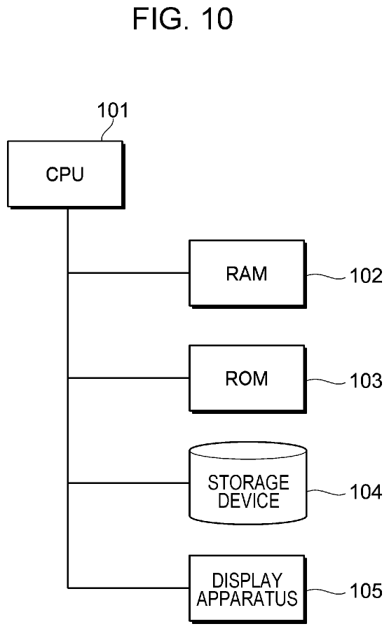

The summarizing apparatus 10 according to the present exemplary embodiment is implemented by using a computer. Various information processing apparatuses, especially a personal computer, may be used as an investigation target apparatus 20. FIG. 10 is a diagram illustrating an exemplary hardware configuration of a computer serving as the summarizing apparatus 10 or an investigation target apparatus 20. Each of the computers forming the summarizing apparatus 10 and an investigation target apparatus 20 includes a central processing unit (CPU) 101, which is a computing unit, and a random access memory (RAM) 102, a read only memory (ROM) 103, and a storage device 104 which are storage units. Each of the computers also includes a display apparatus 105. The RAM 102, which is a main storage device (main memory), is used as a work memory used when the CPU 101 performs computing. The ROM 103 holds programs and data such as prepared setting values. The CPU 101 reads the programs and the data directly from the ROM 103 to perform processes. The storage device 104 is a storage unit for programs and data. The storage device 104 stores programs. The CPU 101 reads the programs stored in the storage device 104 onto the main storage device for execution. The storage device 104 stores results of processes performed by the CPU 101. As the storage device 104, for example, a magnetic disk device or a solid state drive (SSD) is used. The display apparatus 105 displays various notification screens and operation screens. As the display apparatus 105, for example, a liquid-crystal display or an organic light-emitting diode (OLED) display is used.

As in the implementation example illustrated in FIG. 8, when the auditing system 100 is implemented by allocating the functions to the summarizing apparatus 10 and each investigation target apparatus 20, the information acquiring unit 110 and the information processor 120a are implemented, for example, through execution of programs by the CPU 101 of the computer forming the investigation target apparatus 20. The information holding unit 130 is implemented by the RAM 102 or the storage device 104 of the computer forming each investigation target apparatus 20. The information processor 120b and the output controller 140 are implemented, for example, through execution of programs by the CPU 101 of the computer forming the summarizing apparatus 10.

As in the implementation example illustrated in FIG. 9, when the auditing system 100 is implemented in the summarizing apparatus 10, the information acquiring unit 110, the information processor 120, and the output controller 140 are implemented, for example, through execution of programs by the CPU 101 of the computer forming the summarizing apparatus 10. The information holding unit 130 is implemented by the RAM 102 or the storage device 104 of the computer forming the summarizing apparatus 10.

The summarizing apparatus 10 may be implemented by using various information apparatuses in which the computer as illustrated in FIG. 10 is installed. For example, the summarizing apparatus 10 may be implemented by using a computer installed as a controller of an image processing apparatus serving as a multifunction device provided, for example, with the print function, the reading function, the copy function, and the facsimile function.

### Exemplary Display of an Investigation Result

Exemplary display of an assessment result notified to a user of the summarizing apparatus 10 will be described. According to the present exemplary embodiment, before transmission of an assessment result to the auditing server 30, a user is notified through display output of the assessment result. Thus, the user checks information which is to be transmitted to the auditing server 30. When necessary, the user may stop transmission of the assessment result to the auditing server 30.

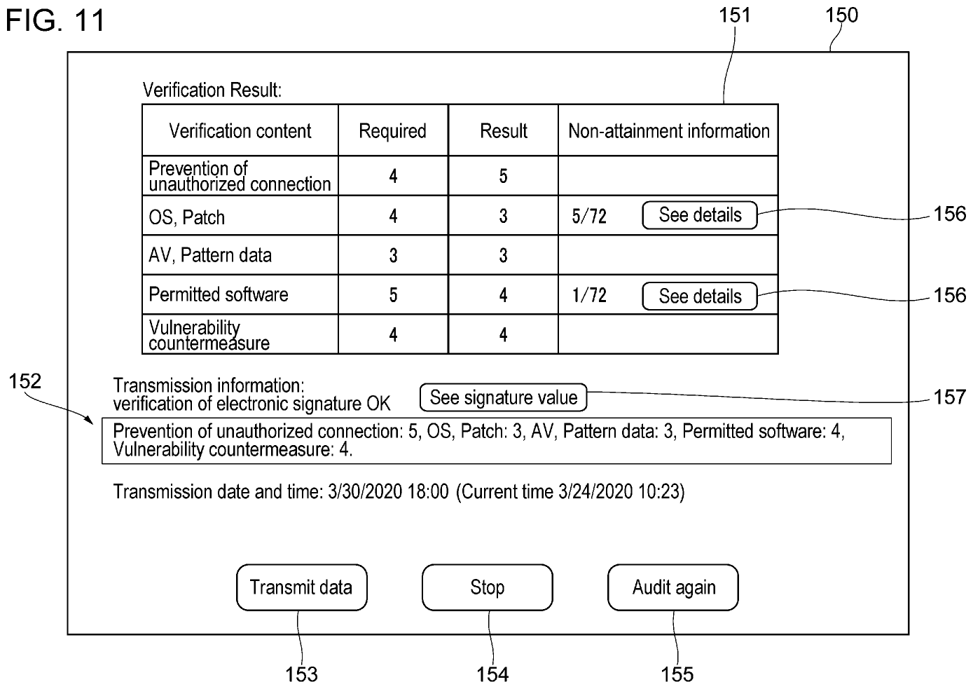

FIG. 11 is a diagram illustrating an exemplary configuration of a display screen on which a user is notified of an assessment result. A display screen 150 illustrated in FIG. 11 is generated by the output controller 140 on the basis of an assessment result in plain text, and is displayed, for example, on the display apparatus 105 illustrated in FIG. 10. The display screen 150 illustrated in FIG. 11 also serves as a user interface (UI) screen for receiving user operations for transmitting instructions to the auditing system 100. The display screen 150 illustrated in FIG. 11 is merely an example of an output method for notifying a user of an assessment result. For example, the display content, the screen configuration, and how to output the assessment result are not limited to those on the display screen 150 illustrated in FIG. 11.

The display screen 150 illustrated in FIG. 11 includes a verification-result display portion 151, a transmission-information display portion 152, instruction buttons 153, 154, and 155, and display buttons 156 and 157. The verification-result display portion 151 is a display portion for presentation of the security-level assessment results for the assessment items which are obtained by the information processor 120 of the auditing system 100. In the illustrated example, for each of the items, which are “Prevention of unauthorized connection”, “OS, Patch”, “AV (antivirus software), Pattern data”, “Permitted software (introduced software)”, and “Vulnerability countermeasure”, the security level (described in “Required” in FIG. 11) which is required in audit, the assessment result (described in “Result” in FIG. 11) for an investigation target apparatus 20, and “Non-attainment information” are displayed. “Non-attainment information” is a field for indicating an assessment item for which the assessment result does not reach the security level.

In the illustrated example, for the item, “Prevention of unauthorized connection”, the required security level is “4”, and the security level in the assessment result is “5” which reaches the required security level. For the item, “OS, Patch”, the required security level is “4”, and the security level in the assessment result is “3” which does not reach the required security level. For the item, “AV, Pattern data”, the required security level is “3”, and the security level in the assessment result is “3” which reaches the required security level. For the item, “Permitted software”, the required security level is “5”, and the security level in the assessment result is “4” which does not reach the required security level. For the item, “Vulnerability countermeasure”, the required security level is “4”, and the security level in the assessment result is “4” which reaches the required security level.

As described above, for the items, “OS, Patch” and “Permitted software”, the assessment results do not reach the required security levels. Thus, in the “Non-attainment information” fields, the display buttons 156 are displayed. Each display button 156 is a button object for displaying detailed information of the corresponding assessment item. When a display button 156 is selected through a user operation, detailed information of the assessment result about the assessment item, for which the selected display button 156 is displayed, is displayed. In the example illustrated in FIG. 11, specifically, when the display button 156 displayed in the “Non-attainment information” field for the “OS, Patch” item is selected, detailed information about the “OS, Patch” item is displayed. When the display button 156 displayed in the “Non-attainment information” field of the “Permitted software” item is selected, detailed information about the “Permitted software” item is displayed. A display button 156 is selected, for example, through an operation such as a mouse click.

Detailed information of an assessment result displayed through selection of a display button 156 is exemplary information which describes the assessment item for the assessment result that does not reach the required security level, and which is used to specify matters necessary to satisfy the required security level. As the detailed information, various information about the assessment may be displayed. For example, the system information about the corresponding assessment item, or the system information, from which the assessment result is produced, may be displayed. The method of displaying the detailed information is not particularly limiting. The display of the display screen 150 may be switched to a display screen for the detailed information. Alternatively, a window different from the display screen 150 may be opened, and the detailed information may be displayed.

The transmission-information display portion 152 is a display portion in which the assessment result in plain text is displayed. In the illustrated example, the names and assessment result values of the items in the verification-result display portion 151 are displayed. The user of the summarizing apparatus 10 may refer to the display in the transmission-information display portion 152 to check the assessment result. In the example illustrated in FIG. 11, the display button 157 is displayed near the transmission-information display portion 152. The display button 157 is a button object for displaying the signature value of the signed assessment result that is to be transmitted to the auditing server 30. When the display button 157 is selected through a user operation, the signature value of the transmission data (encrypted and signed assessment result) corresponding to the assessment result displayed on the display screen 150 is displayed. The signature value may be displayed, for example, in a pop-up window opened on the display screen 150. The display button 157 is selected, for example, through an operation such as a mouse click.

The instruction buttons 153, 154, and 155 are button objects for the user to input operations on the assessment result displayed on the display screen 150. The example in FIG. 11 illustrates the instruction button 153 for transmitting an instruction to transmit the assessment result data, the instruction button 154 for transmitting an instruction to stop transmission of the assessment result data, and the instruction button 155 for transmitting an instruction to assess again the investigation target apparatus 20 that is the target of the assessment result displayed on the display screen 150. When any of the instruction buttons 153, 154, and 155 is selected through a user operation, a process is performed in the summarizing apparatus 10 on the basis of the instruction issued by the selected instruction button 153, 154, or 155. Specifically, selection of the instruction button 153 causes the transmission data (the encrypted and signed assessment result) corresponding to the assessment result displayed on the display screen 150 to be transmitted to the auditing server 30. Selection of the instruction button 154 causes transmission of the transmission data to be stopped. Selection of the instruction button 155 causes system information to be acquired, for reassessment of the security level, from the investigation target apparatus 20 corresponding to the assessment result displayed on the display screen 150.

In reassessment of the security level, after countermeasures are taken for the assessment items for which the assessment results do not reach the required security levels, system information is acquired again. Thus, the assessment results for the items may reach the required security levels. For example, in the example illustrated in FIG. 11, the latest patch is applied to the OS, and software which causes a reduction in the security level is deleted from the installed software. Thus, the assessment results for these items are improved.

An investigation target apparatus 20 may be used in multiple businesses whose types are different from each other. The security level required for the investigation target apparatus 20 in audit may be set in accordance with business using the investigation target apparatus 20.

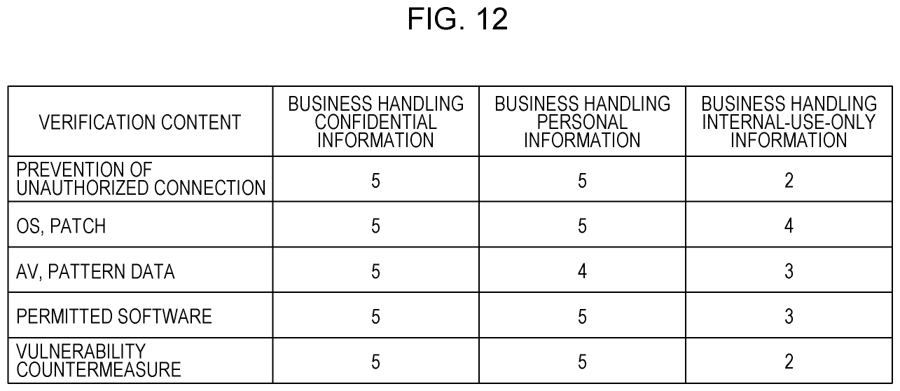

FIG. 12 is a diagram illustrating exemplary setting of the security levels required individually for the types of business. The example in FIG. 12 illustrates, for each assessment item, the security levels required individually for the following three types of business: business handling confidential information; business handling personal information; business handling internal-use-only information. The example in FIG. 12 illustrates the five assessment items which are the same as those in the verification-result display portion 151 of the display screen 150 in FIG. 11, that is, “Prevention of unauthorized connection”, “OS, Patch”, “AV, Pattern data”, “Permitted software”, and “Vulnerability countermeasure”.

Referring to the example in FIG. 12, business handling confidential information requires security level 5 for all the five items. Business handling personal information requires security level 4 for “AV, Pattern data” and security level 5 for the other items. Business handling internal-use-only information requires security level 2 for “Prevention of unauthorized connection”, security level 4 for “OS, Patch”, security level 3 for “AV, Pattern data”, security level 3 for “Permitted software”, and security level 2 for “Vulnerability countermeasure”. Thus, for example, in the case of the investigation target apparatus 20 for which the assessment result is displayed on the display screen 150 in FIG. 11, the assessment results for four items excluding “Prevention of unauthorized connection” do not reach the requires security levels in use of the investigation target apparatus 20 in business handling confidential information and business handling personal information. In contrast, in use of the investigation target apparatus 20 in business handling internal-use-only information, the assessment results for four items excluding “OS, Patch” reach the required security levels. It is seen that measures, such as applying the latest patch to the investigation target apparatus 20, are taken so that the investigation target apparatus 20 may be used in business handling internal-use-only information.

### Modified Examples in Implementation of the Auditing System 100

In each of the implementation examples of the auditing system 100 which are described by referring to FIGS. 8 and 9, assessment results for the respective assessment items which are obtained through assessment of the system information are transmitted from the summarizing apparatus 10 to the auditing server 30. Thus, without presentation of specific system information of each investigation target apparatus 20 to the auditing server 30, it may be determined, for audit, whether the investigation target apparatus 20 has the required security level.

Alternatively, as a modified example of the embodiment example, an assessment result is not necessarily transmitted from the summarizing apparatus 10 to the auditing server 30, and the summarizing apparatus 10 may determine whether the assessment result satisfies the required security level, and may transmit the determination result to the auditing server 30. In this case, for example, the summarizing apparatus 10 includes the information processor 120 and the information holding unit 130 of the auditing system 100. The information holding unit 130 holds information (hereinafter referred to as “requirement criterion information”) indicating the required security levels for the assessment items as illustrated in FIG. 12. The information processor 120 compares the requirement criterion information with the assessment result for the system information acquired from an investigation target apparatus 20. The information processor 120 determines whether the target investigation target apparatus 20 satisfies the required security level. The information processor 120 encrypts and signs the determination result. The output controller 140 transmits the encrypted and signed determination result to the auditing server 30.

In the implementation examples, processes, that is, determination of an assessment result and encryption and signing of the determination result, are performed by the information processor 120 in the analysis-preventing environment constructed in the summarizing apparatus 10. In this case, the requirement criterion information used in determination of an assessment result is held in the storage unit included in the analysis-preventing environment. The output controller 140 may display the determination result as well as the assessment result before transmission of the determination result to the auditing server 30 so as to notify a user.

The exemplary embodiment of the present disclosure is described. The technical scope of the present disclosure is not limited to the exemplary embodiment described above. For example, in the exemplary embodiment described above, an assessment result is encrypted and the encrypted assessment result is signed. Alternatively, after an assessment result is signed, the signed assessment result may be encrypted. In the implementation example described by referring to FIG. 8, an encrypted assessment result and the assessment result in plain text are transmitted from each investigation target apparatus 20 to the summarizing apparatus 10. If the summarizing apparatus 10 may decrypt, in the analysis-preventing environment, the assessment result which has been encrypted by the investigation target apparatus 20, the assessment result in plain text is not necessarily transmitted. Other than these, various changes and replacement of a configuration, which are made without departing from the scope of the technical idea of the present disclosure, are encompassed in the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An auditing system comprising:
a processor configured to
obtain system information as information about apparatus safety from an apparatus that is to be audited, the system information describing predetermined items,
convert, on a basis of content of each of the items, the system information to safety-degree information indicating a degree of safety,
encrypt the safety-degree information in an environment in which a measure is taken for protection against an analysis action, and
output the encrypted safety-degree information and the safety-degree information in plain text.

2. The auditing system according to claim 1,
wherein the processor is configured to
encrypt the safety-degree information by using an encryption key associated with the auditing system, and
perform electronic signature on the safety-degree information.

3. The auditing system according to claim 2,
wherein the encryption key and a signature key used for the electronic signature are held by the auditing system so as not to be disclosed, and
wherein the processor is configured to perform the electronic signature in the environment in which a measure is taken for protection against an analysis action.

4. The auditing system according to claim 1,
wherein the processor is configured to
cause a display apparatus to display information indicating whether the degree of safety which is indicated by the safety-degree information satisfies a degree of safety required for the auditing system, and
receive an instruction from a user and transmit the encrypted safety-degree information to an external apparatus.

5. The auditing system according to claim 4,
wherein the processor is configured to
cause the display apparatus to perform the display and to display the safety-degree information in plain text.

6. The auditing system according to claim 5,
wherein the processor is configured to
receive an instruction from a user and cause the display apparatus to display a matter necessary to achieve a state in which the degree of safety indicated by the safety-degree information satisfies the degree of safety required for the auditing system.

7. An auditing system comprising:
means for obtaining system information as information about apparatus safety from an apparatus that is to be audited, the system information describing predetermined items;
means for converting, on a basis of content of each of the items, the system information to safety-degree information indicating a degree of safety;
means for encrypting the safety-degree information in an environment in which a measure is taken for protection against an analysis action; and
means for outputting the encrypted safety-degree information and the safety-degree information in plain text.
